(19) United States
(12) Patent Application Publication
(10) Pub. No.: US 2004/0052537 A1
(43) Pub. Date: Mar. 18, 2004

(54) Thermal noise reduction technique for optical receivers using identical amplifier circuits

(76) Inventors: Walid Kamali, Duluth, GA (US); Fred S. Hirt, Brookfield, IL (US)

Correspondence Address: Scientific-Atlanta, Inc., Intellectual Property Dept. MS 4.3.518, 5030 Sugarloaf Parkway, Lawrenceville, GA, 30044, US

(21) Appl. No.: 10/245,203

(22) Filed: Sep. 17, 2002

(51) Int. Cl. H04B 10/00; H04B 10/06

(52) U.S. Cl. 398/202; 398/208

(57) ABSTRACT

The present invention is directed towards an optical receiver including a noise reduction technique that mitigates internally generated thermal noise and reduces input signal losses. The optical receiver includes a photodiode for providing an electrical signal in accordance with a received optical signal and an amplification circuit. Two identical amplifier circuits included in the amplification circuit are connected in DC bias series, thereby biasing the photodiode with their potential difference. Advantageously, the absence of a conventional photodiode bias circuit both reduces the input signal losses and limits the amount of thermal noise that is typically conventionally generated.

### FIELD OF THE INVENTION

This invention relates generally to broadband communications systems, such as cable television networks, and more specifically to an optical receiver that is suitable for use in the broadband communications system, the optical receiver including a technique that reduces both the thermal noise and the input RF signal losses that are inherently generated in the optical receiver.

### BACKGROUND OF THE INVENTION

FIG. 1 is a block diagram illustrating an example of a conventional ring-type broadband communications system, such as a two-way hybrid/fiber coaxial (HFC) network. It will be appreciated that other networks exist, such as a star-type network. These networks may be used in a variety of systems, including, for example, cable television networks, voice delivery networks, and data delivery networks to name but a few. The broadband signals transmitted over the networks include multiple information signals, such as video, voice, audio, and data, each having different frequencies. Headend equipment included in a headend facility 105 receives incoming information signals from a variety of sources, such as off-air signal source, a microwave signal source, a local origination source, and a satellite signal source and/or produces original information signals at the facility 105. The headend 105 processes these signals from the sources and generates forward, or downstream, broadcast signals that are delivered to a plurality of subscriber equipment 110. The broadcast signals can be digital or analog signals and are initially transported via optical fiber 115 using any chosen transport method, such as SONET, gigabit (G) Ethernet, 10 G Ethernet, or other proprietary digital transport methods. The broadcast signals are typically provided in a forward bandwidth, which may range, for example, from 45 MHz to 870 MHz. The information signals may be divided into channels of a specified bandwidth, e.g., 6 MHz, that conveys the information. The information is in the form of carrier signals that transmit the conventional television signals including video, color, and audio components of the channel. Also transmitted in the forward bandwidth may be telephony, or voice, signals and data signals.

Optical transmitters (not shown), which are generally located in the headend facility 105, convert the electrical broadcast signals into optical broadcast signals. In most networks, the first communication medium 115 is a long haul segment that transports the signals typically having a wavelength in the 1550 nanometer (nm) range. The first communication medium 115 carries the broadcast optical signal to hubs 120. The hubs 120 may include routers or switches to facilitate routing the information signals to the correct destination location (e.g., subscriber locations or network paths) using associated header information. The optical signals are subsequently transmitted over a second communication medium 125. In most networks, the second communication medium 125 is an optical fiber that is typically designed for shorter distances, and which transports the optical signals over a second optical wavelength, for example, in the 1310 nm range.

From the hub 120, the signals are transmitted to an optical node 130 including an optical receiver and a reverse optical transmitter (not shown). The optical receiver converts the optical signals to electrical, or radio frequency (RF), signals for transmission through a distribution network. The RF signals are then transmitted along a third communication medium 135, such as coaxial cable, and are amplified and split, as necessary, by one or more distribution amplifiers 140 positioned along the communication medium 135. Taps (not shown) further split the forward RF signals in order to provide the broadcast RF signals to subscriber equipment 110, such as set-top terminals, computers, telephone handsets, modems, televisions, etc. It will be appreciated that only one subscriber location 110 is shown for simplicity, however, each distribution branch may have as few as 500 or as many as 1000 subscriber locations. Additionally, those skilled in the art will appreciate that most networks include several different branches connecting the headend facility 105 with several additional hubs, optical nodes, amplifiers, and subscriber equipment. Moreover, a fiber-to-the-home (FTTH) network 145 may be included in the system. In this case, optical fiber is pulled to the curb or directly to the subscriber location and the optical signals are not transmitted through a conventional RF distribution network.

In a two-way network, the subscriber equipment 110 generates reverse RF signals, which may be generated for a variety of purposes, including video signals, e-mail, web surfing, pay-per-view, video-on-demand, telephony, and administrative signals. These reverse RF signals are typically in the form of modulated RF carriers that are transmitted upstream in a typical United States range from 5 MHz to 40 MHz through the reverse path to the headend facility 105. The reverse RF signals from various subscriber locations are combined via the taps and passive electrical combiners (not shown) with other reverse signals from other subscriber equipment 110. The combined reverse electrical signals are amplified by one or more of the distribution amplifiers 140 and generally converted to optical signals by the reverse optical transmitter included in the optical node 130 before being transported through the hub ring and provided to the headend facility 105.

Along with the desired information signals, noise signals are also present within the communications system. Noise signals can enter the system via faulty coaxial connectors, for example, or they can be inherently generated within the communications equipment, such as amplifiers, optical transmitters, or optical receivers. The noise signals are amplified via various communications equipment and are aggregated with other noise signals and transported along with the information signals to the headend facility 105. Disadvantageously, the noise signals may interfere with the signal processing causing errors or poor service quality.

As a result, system operators need to focus on noise reduction techniques. Thus, the present invention is directed towards reducing the noise that is inherent in optical receivers.

### BRIEF DESCRIPTION OF THE DRAWINGS

FIG. 1 is a block diagram illustrating an example of a conventional ring-type broadband communications system, such as a two-way hybrid/fiber coaxial (HFC) network.

FIG. 2 is a schematic of a conventional optical receiver 200 that is suitable for use in the headend facility 105 and in the nodes 130 for receiving optical signals from an optical transmitter and for providing electrical signals.

FIG. 3 illustrates a second embodiment of a conventional bias circuit 305 that is suitable for use in a conventional optical receiver 300.

FIG. 4 is a schematic of an optical receiver including a noise reduction technique in accordance with the present invention.

### DETAILED DESCRIPTION OF A PREFERRED EMBODIMENT

The present invention will be described more fully hereinafter with reference to the accompanying drawings in which like numerals represent like elements throughout the several figures, and in which an exemplary embodiment of the invention is shown. This invention may, however, be embodied in many different forms and should not be construed as being limited to the embodiment set forth herein; rather, the embodiment is provided so that this disclosure will be thorough and complete, and will fully convey the scope of the invention to those skilled in the art. For example, the present invention is explained relative to an optical receiver that is suitable for use in a communications system; however, the present invention can also be used in other communications equipment that needs to reduce noise, which is inherently generated in the electrical circuitry, commonly referred to as thermal noise. The present invention is described more fully hereinbelow.

Specifically, the present invention is directed towards a thermal noise reduction technique that is suitable for use in an optical receiver. The optical receiver includes a photodiode, e.g., a PIN diode, for converting received optical signals into electrical signals. The optical receiver further includes an amplification circuit including push-pull transimpedance amplifiers that amplify the electrical signal for further transmission through the communications system. Notably, the optical receiver in accordance with the present invention includes a technique for reducing the conventionally inherent, i.e., thermal, noise signals that are generated in conventional optical receivers.

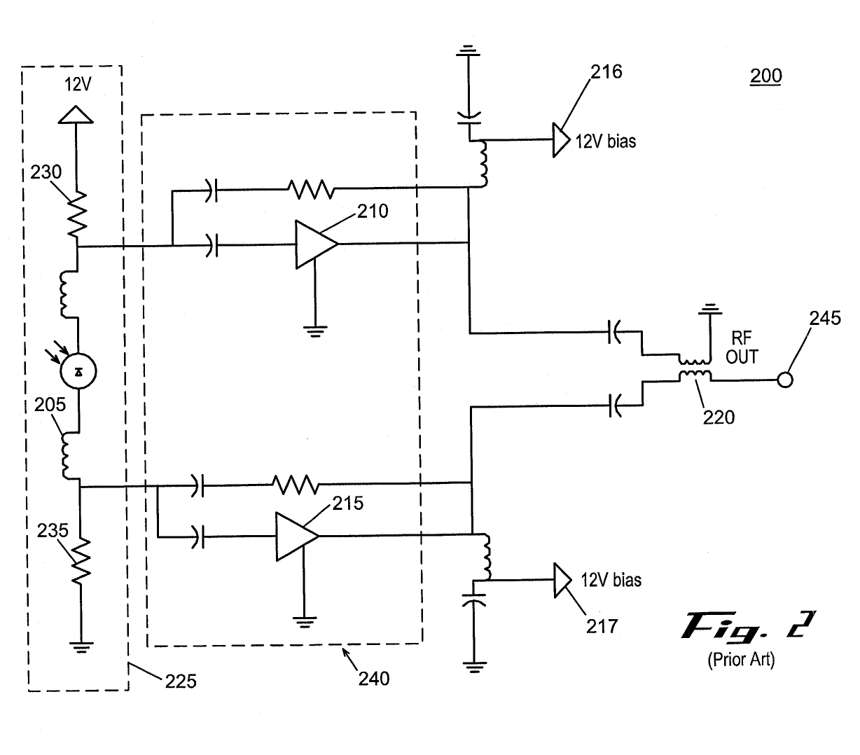

FIG. 2 is a schematic of a conventional optical receiver 200 that is suitable for use in the headend facility 105 and in the nodes 130 for receiving optical signals from an optical transmitter and for providing electrical signals. Included in the optical receiver 200 is a photodiode 205 for receiving the optical signals and for providing electrical signals in accordance therewith. Two identical push-pull transimpedance amplifiers 210 and 215 included in an amplification circuit 240 amplify the electrical signals prior to combining the electrical signals into a single RF electrical signal. Two 12 volt (V) power supplies 216, 217 each power one of the amplifiers 210, 215. Finally, a balanced-to-unbalanced electrical transformer, i.e., balun 220, or other combining means is typically used to provide the combined RF electrical signal. It will be appreciated that the amplification circuit 240 can be discrete components that are assembled on the printed circuit board, or preferably, can be included in a monolithic Gallium Arsenide (GaAs) chip or Silicon Germanium (Si—Ge) microelectronic monolithic circuit to name but a couple examples.

Complicated bias circuits are also included in conventional optical receivers that are used in conjunction with the photodiode 205 and the transimpedance amplifiers 210, 215 in order to simultaneously apply the bias necessary to utilize photodiode 205 while keeping the bias voltage from appearing at the inputs of the transimpedance amplifiers 210, 215, thereby disrupting their proper operation. Disadvantageously, such bias control circuits reduce the RF signal coupled from the photodiode to the transimpedance amplifiers. Some bias control circuits are designed to minimize this negative effect, however, it is impossible to totally eliminate the problem. In addition to signal loss, the bias circuits, through resistances intrinsic to their design, generate thermal noise, which is also known as Johnson noise. This reduction of RF signal along with an increase in thermal noise that is generated in the bias circuitry together act to reduce the ratio of signal (or carrier level) to noise, or CNR (carrier to noise ratio). Since high CNR values are necessary in optical and electrical distribution networks for efficient distribution of high quality signals, any reduction in CNR is detrimental to proper system operation.

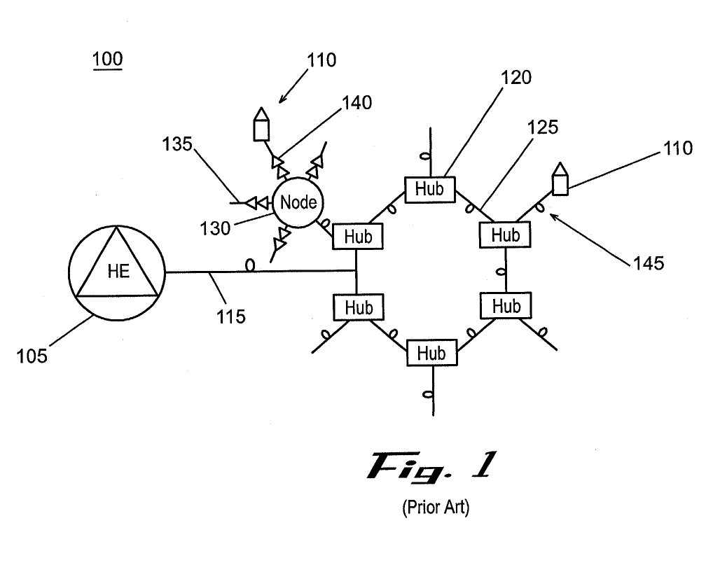

One example of a conventional bias circuit 225 is shown in FIG. 1. The bias circuit 225 includes high impedance resistors 230, 235, for example, 1 kilo ohm (KΩ), that are connected in series on either side of the photodiode 205 and are supplied a current and voltage with a 12 V power supply. Due to the high resistive values, however, thermal noise is introduced into the circuit. Accordingly, the thermal noise is subsequently amplified via the amplification circuit 240, thereby resulting in amplified thermal noise signals being transmitted along with the information signals at the RF output port 245.

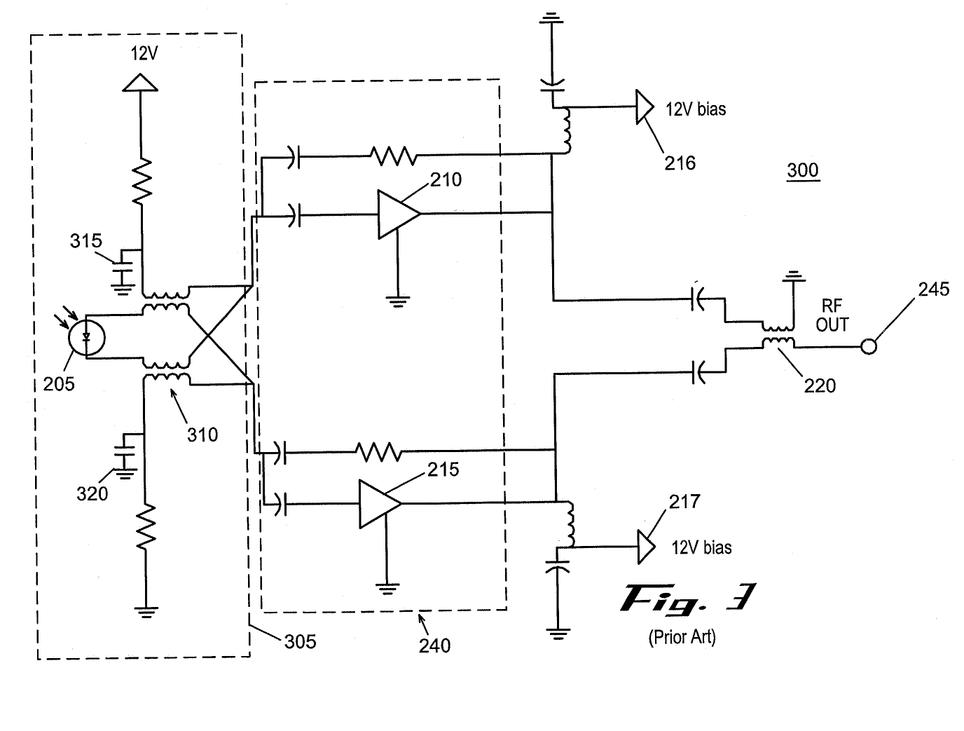

FIG. 3 illustrates a second embodiment of a conventional bias circuit 305 that is suitable for use in a conventional optical receiver 300. A magnetic transformer 310 configured as a 4:1 impedance transformer network is used along with a 12 V power supply to bias the photodiode 205. Accordingly, thermal noise is also generated in this bias circuit 305 due to the resistance generated by the coils of the magnetic transformer 310. Bypass capacitors 315, 320 are used to provide the low impedance path to ground that is required.

It will be appreciated that communications equipment having resistive networks intrinsically generate thermal noise. The thermal noise voltage that is produced by components containing a resistance is determined by the formula: Vₜₕ=√(4 kTBR), where k=Boltzmann's constant (1.38×10⁻²³ joules/°K.), T=Absolute temperature (°K.), B=Noise bandwidth (Hz), R=Resistance (Ω), and Vₜₕ is the Root-Mean-Square (RMS) voltage present across the component. Thus, it is seen that the noise voltage increases in proportion to the square root of the component's resistance, making high resistance devices undesirable sources of thermal noise. The thermal noise current that is produced by components containing a resistance is determined by the formula: Iₜₕ=√(4 kTB/R), where Iₜₕ is the RMS current flowing through the component. Thus, it will be appreciated that the noise current increases in inverse proportion to the square root of the component's resistance. Additionally, thermal noise is uniformly present throughout the bandwidth, for example, from 5 MHz to 40 MHz or from 45 MHz to 870 MHz. Typically, care is taken in the design of communications equipment to ensure proper processing despite received noise levels or the equipment is designed to limit the amount of transmitted noise.

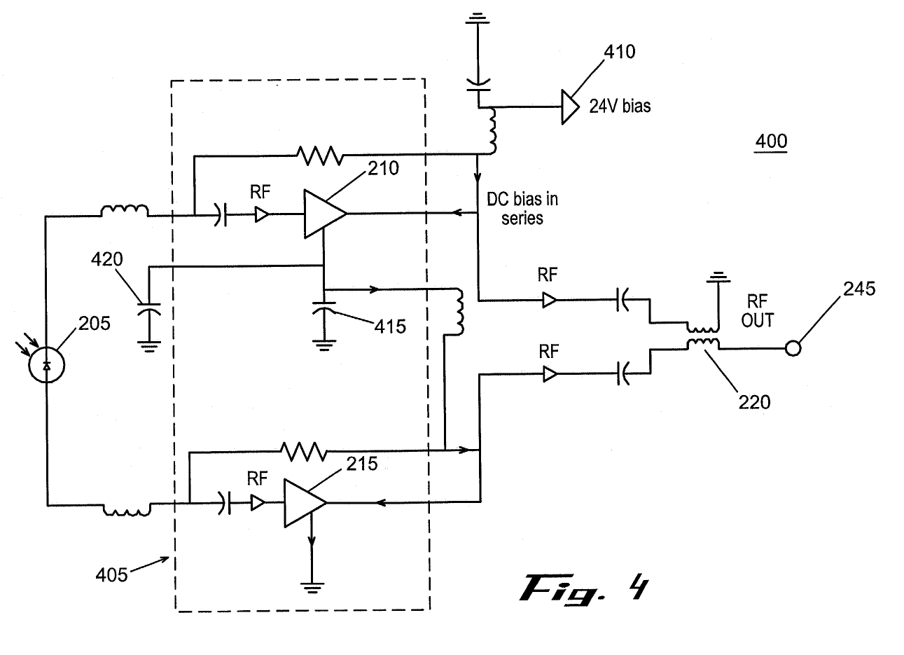

FIG. 4 is a schematic of an optical receiver including a noise reduction technique in accordance with the present invention. The photodiode 205 receives the optical signals and converts them into electrical signals. An amplification circuit 405 amplifies the electrical signals to provide amplified RF signals to the RF output port 245. In accordance with the present invention, however, the conventional bias circuits 225, 305 are not included. Advantageously, by utilizing the noise reduction technique of the present invention, the photodiode 205 of the optical receiver 400 no longer requires a conventional bias circuit.

The direct current (DC) voltage required to bias each of the push-pull amplifier circuits 210, 215 is, for example, 12 V. Additionally, the DC voltage required to bias the photodiode 205 is also typically 12 V. Accordingly, a common 24 V DC power supply 410 is used to bias the identical amplifier circuits 210, 215 by rewiring the amplifiers 210, 215 in DC bias series in order to use the common current supplied by the 24 V power supply 410. The open arrows denoted on FIG. 4 show the two amplifier circuits 210, 215 receiving the DC bias current in series. Additionally, the photodiode 205 is biased using the difference of the potential voltage between the two amplifier stages 210, 215, i.e., 12 V.

As mentioned, the amplifier circuits 210, 215 are identical and are preferably constructed as an amplification circuit that is assembled on a monolithic GaAs or Si—Ge chip. Accordingly, this construction allows the amplifier circuits 210, 215 to share the common series current from the 24 V power supply 410. Additionally, on-chip 415 and off-chip 420 capacitors decouple the RF signals, which are denoted as the closed arrows on FIG. 4, equally between the individual amplifier circuits 210, 215. The capacitors 415, 420, having a higher potential than ground, are connected to the source of one amplifier that is not connected to ground. Amplifier 210 of FIG. 4 is illustrated as being coupled to the capacitors 415, 420. Alternatively, the amplifiers 210, 215 can be biased with a negative voltage and, therefore, inverted. Amplifier 215 of FIG. 4 would then be coupled to the capacitors 415, 420. It will be appreciated that the capacitors do not have to be included on the amplification circuit chip 405, but can be positioned off the chip. More specifically, a small valued capacitor, such as a 100 pico Farad (pF) capacitor, is placed on the chip 405 and a larger valued capacitor, such as a 0.1 micro Farad (μF) is placed off the chip 405 due to its large physical size. It will be appreciated, however, that the capacitors 415, 420 can either be on or off the chip 405.

In summary, the requirement for a bias circuit is removed from the optical receiver 400 of the present invention. Accordingly, the RF output signal does not include any internally generated bias circuit thermal noise signals that were once present. Nor does it introduce undesirable RF losses into the input signal path. Significantly, this decreases the thermal noise throughout the communications system and aids in the proper processing of the received signals.

What is claimed is:

1. An optical receiver for receiving optical signals and for providing electrical signals, the optical receiver comprising:
a photodiode for converting the optical signals into the electrical signals;
amplifier circuits coupled to the photodiode for amplifying the electrical signals, wherein the amplifier circuits are DC biased in series with a single potential voltage, and wherein the photodiode receives a difference in the potential voltage between the amplifier circuits,
whereby the optical receiver exhibits both reduced thermal noise and reduced input electrical signal losses due to the absence of a bias circuit used in conjunction with the photodiode.

2. The optical receiver of claim 1, further comprising:
a single DC power supply for supplying the single potential voltage to the amplifier circuits.

3. The optical receiver of claim 1, wherein the amplifier circuits are identical circuits.

4. The optical receiver of claim 3, wherein the photodiode receives half of the potential voltage.

5. The optical receiver of claim 1, wherein capacitors are coupled to a source output of one amplifier circuit for ensuring that an equal amount of electrical signals are provided to each of the amplifier circuits.

6. The optical receiver of claim 1, further comprising:
a combining means coupled to an output of the amplifier circuits for combining the amplified electrical signals into a single electrical signal.

7. In a communications system for transmitting RF signals, the communications system including optical transmitters for receiving the RF signals and for transmitting optical RF signals to optical receivers, the optical receivers for converting the optical RF signals back to electrical RF signals, the optical receiver comprising:
a photodiode for receiving the optical RF signals, converting the optical RF signals to electrical signals, and for providing a portion of the electrical signals to two amplifier circuits;
an amplification stage including the two amplifier circuits, wherein each of the two amplifier circuits for providing amplified electrical signals at an output, and wherein the two amplifier circuits are DC biased in series;
a DC power supply for supplying a potential voltage and current to the amplification stage,
wherein the photodiode is split between the two amplifier circuits and receives a difference in the potential voltage between the two amplifier circuits; and
a combining means coupled to the outputs of the two amplifier circuits for combining the amplified electrical signals into a combined RF signal,
whereby the optical receiver exhibits both reduced thermal noise and reduced input RF signal losses due to the absence of a bias circuit in conjunction with the photodiode.

8. The communications system of claim 7, wherein the two amplifier circuits are identical circuits.

9. The communications system of claim 8, wherein the photodiode receives half of the potential voltage.

10. The communications system of claim 7, wherein capacitors are coupled to a source output of one amplifier circuit for ensuring that an equal amount of electrical signals are provided to each of the two amplifier circuits.

11. A communications system for transmitting RF signals, the communications system including optical transmitters for receiving the RF signals and for transmitting optical RF signals to optical receivers, the optical receivers for converting the optical RF signals back to electrical RF signals, the communications system comprising:
an optical transmitter for receiving electrical RF signals and for providing optical RF signals; and
an optical receiver coupled to the optical transmitter for providing amplified electrical signals in accordance with the received optical RF signals, the optical receiver comprising:
a photodiode for receiving the optical RF signals and for providing electrical signals;
an amplification stage for receiving the electrical signals and for providing the amplified electrical signals, the amplification stage comprising:
two amplifier circuits each for providing an amplified electrical signal at an output, wherein the two amplifier circuits are DC biased in series;
capacitors coupled to a source output of one amplifier circuit for ensuring that an equal amount of the electrical signals are provided to the two amplifier circuits;
a DC power supplying for supplying a potential voltage to the amplification stage, wherein the photodiode receives a difference in the potential voltage between the two amplifier circuits; and
a combining means coupled to the outputs of the two amplifier circuits for combining each of the amplified electrical signals into a combined RF signal,
wherein the optical receiver exhibits both reduced thermal noise and reduced input electrical signal losses due to the absence of a bias circuit in conjunction with the photodiode.
